(19) United States
(12) Patent Application Publication
(10) Pub. No.: US 2010/0092680 A1
(43) Pub. Date: Apr. 15, 2010

(54) PROCESS FOR PRODUCING METAL CLAD LAMINATE

(76) Inventors: Kenichi Ohga, Tokyo (JP); Satoru Zama, Tokyo (JP)

Correspondence Address: Kazunao Kubotera;Kubotera & Associates, LLC, 200 Daingerfield Road, Suite 202, Alexandria, VA, 22314, US

(21) Appl. No.: 12/311,523

(22) PCT Filed: Oct. 3, 2007
(86) PCT No.: PCT/JP2007/069345

§ 371 Date: Dec. 23, 2009

(30) Foreign Application Priority Data
Oct. 3, 2006 (JP) 2006-271602
Oct. 1, 2007 (JP) 2007-257992

(51) Int. Cl. B05D 3/02

(52) U.S. Cl. 427/383.1

(57) ABSTRACT

With respect to a metal clad laminate wherein a metal layer is to be formed for at least a part of a surface of a flexible polymer film, it becomes clear that it is able to suppress any warpage of the laminate by performing a heat treatment and then a cooling treatment under a state of loading a tension within a range capable of maintaining the laminate to be a flat configuration consistently during the period from heating to cooling. Moreover, it becomes clear that it is able to suppress the warpage without occurrences of an elongation deformation and/or a fracture for the obtained metal clad laminate, by controlling a tension to be loaded at the period of the heat treatment as between 0.03% and 0.3% of a tensile strength in a direction of the tension for the substratum polymer film.

### TECHNICAL FIELD

The present invention relates to a process for producing a metal clad laminate. More specifically, the present invention relates to a process for producing a metal clad laminate with superior flatness comprising a flexible thermoplastic polymer film and a metal layer.

### BACKGROUND ART

A flexible circuit board is used as a circuit board of a portable telephone, a liquid crystal television, or the like, using a liquid crystal polymer film, a polyimide film, or the like as a polymer film coated with a metal (a metal coating polymer film).

The metal coating polymer film has a thickness of several tens microns approximately. The metal coating polymer film tends to have warpage due to a stress during metal deposition in a metal coating process in a gaseous phase, a liquid phase, or the like, or due to non-uniform drying in a post-process of a wet treatment. Especially when a fine circuit is formed on the metal coating polymer film, warpage becomes a problem.

For example, a film metal clad laminate is often used for a flexible circuit board, in which metal layers (a base metal layer/an upper metal conductive layer) are formed on a polyimide resin film with superior heat resistance. The base metal layer is formed of nickel or the like, and the upper metal conductive layer is formed of copper or the like. However, since the film has a high water absorption property, a dimensional accuracy becomes worse under a humid atmosphere. Therefore, attention is focused on a liquid crystal polyester film with superior heat resistance and a low water absorption property as a substitute of the film.

The liquid crystal polyester film has poor adhesion to a metal layer (for example, a Ni layer/a Cu layer). Therefore, patent document 1 has proposed a process for producing a metal clad laminate, in which an adhesive strength between a film and a metal layer is improved through a heat treatment.

Moreover, a polyethylene terephthalate (PET) film, a polyethylene naphthalate (PEN) film, or a polyether ether ketone (PEEK) film is used as a polymer film from a cost point of view.

### Patent Document 1: Japanese Patent No. 3693609

### DISCLOSURE OF THE INVENTION

### Problems to be Solved by the Invention

With the process disclosed in patent document 1, it is possible to improve adhesion. However, when the heat treatment is performed on the metal clad laminate, the metal clad laminate tends to have warpage over an entire portion thereof after cooling or etching the metal layer.

As opposed to a thermosetting film such as a polyimide film, a thermoplastic film such as a liquid crystal polymer, PEEK, or the like tends to easily soften and deform due to heat, thereby deteriorating flatness and dimensional stability thereof. According to the conventional technologies, it is difficult to take advantage of the thermoplastic film with low water absorption property. In particular, when the metal layer is thin in a heat treatment, the metal clad laminate tends to have warpage due to a residual stress in the metal layer. Patent document 1 does not disclose an effective method for solving the problems.

The present invention is presented for solving the above mentioned problems, and an object thereof is to provide a process for producing a metal clad laminate with superior flatness, in which a metal layer is formed on a surface a flexible polymer film.

### Means for Solving the Problem

The present inventors have investigated deeply regarding the above descried conventional problems. As a result, it is found that it is able to suppress warpage of a laminate by performing a heat treatment and a cooling treatment on a metal clad laminate wherein a metal layer is formed for at least a part of a surface of a flexible polymer film under a state of loading a tension within a range capable of maintaining the laminate to be in a flat configuration consistently during an entire period from heating to cooling.

Moreover, it is found that when a tension to be loaded during the heat treatment is set between 0.01 and 0.3% of a tensile strength of the substratum polymer film in a direction of the tension, it is able to suppress warpage without elongation deformation and fracture in the metal clad laminate thus obtained. Here, the direction of the tension is a longitudinal direction (MD direction) or a width direction (TD direction) of the substratum polymer film.

Further, it is found that when a temperature of the heat treatment is controlled 35° C. lower than a melting point temperature (referred to as a Tm hereinafter) of the polymer film of the metal clad laminate, the metal clad laminate thus obtained has a sufficient adhesive strength, and it is able to suppress warpage over an entire portion thereof in a state of sufficiently little amount of a thickness variation before and after the heat treatment. Here, the melting point temperature Tm of the film is defined as a melting peak temperature measured using a differential scanning calorimeter according to a method disclosed in JIS-K7121.

Still further, it is found that the polymer film includes a material having the flexibility such as a PET film, a PEN film, a PEEK film, or the like.

Furthermore, it is found that when a thickness of the metal layer is controlled between 0.1 μm and 20 μm in the heat treatment, it is able to manufacture the metal clad laminate with less warpage over the entire portion thereof. In particular, when the thickness of the metal layer is controlled between 0.1 μm and 0.5 μm in the heat treatment, it is possible to suppress warpage without lowering adhesion and achieve remarkable improvement over the conventional technologies.

The present invention is achieved base on the above described results of the research.

According to a first aspect of the present invention, a process for producing a metal clad laminate having a flexibility and comprising a substratum film formed of a thermoplastic and a metal layer includes a heating/cooling step of performing a heat treatment and a cooling treatment on a laminate formed of the substratum film and the metal layer under a state of receiving a stress within a range capable of consistently maintaining the laminate to be in a flat posture during an entire period of heating and cooling.

Accordingly, it is possible to relax an internal stress difference between the different layers (the metal layer and the film layer) of the metal clad laminate thereby suppressing a warpage. Thus, it is possible to easily obtain the metal clad laminate with superior flatness comprising the flexible thermoplastic polymer film and the metal layer.

According to a second aspect of the present invention, a process for producing a metal clad laminate having flexibility and comprising a substratum film formed of a thermoplastic and a metal layer, includes a laminate forming step of forming the metal layer on at least a part of a surface of the substratum film; and a heating/cooling step of performing a heat treatment and then a cooling treatment on a laminate formed in the laminate forming step under a state of receiving a tension within a range capable of consistently maintaining the laminate to be in a flat posture during an entire period of heating and cooling. The substratum film is a polymer film having flexibility.

Accordingly, it is possible to relax an internal stress difference between the different layers (the metal layer and the film layer) of the metal clad laminate, thereby suppressing a warpage. Moreover, when the polymer film of thermoplastic is used as the substratum film, and heat higher than a predetermined temperature is applied to the laminate, it is possible to form the metal clad laminate in which the film layer and the metal layer are adhered without an adhesion layer.

According to a third aspect of the present invention, in the process for producing the metal clad laminate in the first or the second aspect of the present invention, in the heating/cooling step, the laminate receives the tension between 0.01% and 0.3% of a tensile strength of the substratum film within the range capable of maintaining the laminate to be in the flat posture.

According to a fourth aspect of the present invention, in the process for producing the metal clad laminate in the first or the second aspect, in the heating/cooling step, the laminate receives the tension between 0.015% and 0.15% of a tensile strength of the substratum film within the range capable of maintaining the laminate to be in the flat posture.

According to a fifth aspect of the present invention, in the process for producing the metal clad laminate in the first or the second aspect, in the heating/cooling step, the laminate receives the tension between 0.02% and 0.1% of a tensile strength of the substratum film within the range capable of maintaining the laminate to be in the flat posture.

In the third to the fifth aspects, it is able to suppress a plastic deformation of the laminate, especially the substratum film. As a result, it is possible to suppress a warpage without a fracture in the metal clad laminate thus obtained. For example, in a case of loading a tension on a film in a rolled state in a film flow direction, the tension corresponds to between 0.01% and 0.3% of the tensile strength of the film in the film flow direction (more preferably between 0.015% and 0.15% thereof, and further preferably between 0.02% and 0.1% thereof).

According to a sixth aspect of the present invention, in the process for producing the metal clad laminate in one of the first to the fifth aspects, in the heating/cooling step, the laminate has a temperature having a peak temperature in a temperature range lower than a melting point temperature of the substratum film by between 35° C. and 85° C. in the heat treatment.

According to a seventh aspect of the present invention, in the process for producing the metal clad laminate in one of the first to the fifth aspects, in the heating/cooling step, the laminate has a temperature having a peak temperature in a temperature range lower than a melting point temperature of the substratum film by between 50° C. and 70° C. in the heat treatment.

When the peak temperature is higher than a temperature lower than the melting point temperature of the substratum film by 35° C., the substratum film is elongated, thereby increasing a warpage. When the peak temperature is lower than the temperature lower than the melting point temperature of the substratum film by 85° C., an adhesive strength between the film and the metal layer is not sufficient for a practical use. Therefore, when the peak temperature is within the temperature range lower than a melting point temperature of the substratum film by between 35° C. and 85° C., it is possible to suppress a warpage. Moreover, when the peak temperature is within the temperature range lower than the melting point temperature of the substratum film by between 50° C. and 70° C., it is possible to suppress a warpage further.

According to an eighth aspect of the present invention, in the process for producing the metal clad laminate in one of the first to the seventh aspects, the laminate is cooled down from a temperature of the heat treatment to a temperature lower than the melting point temperature of the substratum film by not less than 110° C., while controlling the tension loaded to the laminate within the range capable of maintaining the laminate to be in the flat posture.

When the tension loaded to the laminate exceeds the range capable of maintaining the laminate to be in the flat posture at the temperature higher than the temperature lower than the melting point temperature of the substratum film by 110° C. during the cooling step of the laminate, a warpage or a curl may occur in the laminate, especially in the substratum film. At the temperature not higher than the temperature lower than the melting point temperature of the film by 110° C., a warpage does not occur unless an excessive force is applied thereto. Therefore, it is able to suppress a warpage in the laminate through cooling the substratum film to the temperature lower than the melting point temperature by 110° C. after the heat treatment, with controlling the tension loaded to the laminate within the range capable of maintaining the laminate to be in the flat posture.

According to a ninth aspect of the present invention, in the process for producing the metal clad laminate in one of the first to the eighth aspects, in the heating/cooling step, the metal layer has a thickness between 0.1 μm and 20 μm.

According to a tenth aspect of the present invention, in the process for producing the metal clad laminate in one of the first to the eighth aspects in the heating/cooling step, the metal layer has a thickness between 0.1 μm and 0.5 μm.

Accordingly, it is able to manufacture the metal clad laminate having less warpage for a whole of the laminate. In particular, the effect becomes to be remarkable when the metal layer has the thickness between 0.1 μm and 0.5 μm in the heat treatment.

According to an eleventh aspect of the present invention, in the process for producing the metal clad laminate in one of the first to the tenth aspects, the metal layer is formed of copper, a copper alloy, nickel, or a nickel alloy.

According to a twelfth aspect of the present, in the process for producing the metal clad laminate in one of the first to the eleventh aspects, the substratum film is a polymer resin film capable of forming a molten phase with an optical anisotropy.

Accordingly, when a plating treatment is performed on a polymer film to be the substratum using a chemical or the like, the substratum film does not absorb the chemical to a large extent. It is possible to suppress a warpage for a whole of the laminate without lowering a property of the substratum.

According to a thirteenth aspect of the present invention, in the process for producing the metal clad laminate in one of the first to the eleventh aspects, the substratum film is formed of a polyethylene terephthalate (PET) resin.

According to a fourteenth aspect of the present invention, in the process for producing the metal clad laminate in one of the first to the eleventh aspects, the substratum film is formed of a polyethylene naphthalate (PEN) resin.

According to a fifteenth aspect of the present invention, in the process for producing the metal clad laminate in one of the first to the eleventh aspects, the substratum film is formed of a polyether ether ketone (PEEK) resin.

In the thirteenth to the fifteenth aspects, it is possible to suppress a warpage for a whole of a laminate without lowering a property of the substratum, similar to the twelfth aspect.

According to a sixteenth aspect of the present invention, the process for producing the metal clad laminate in one of the first to the fifteenth aspects further includes a copper plating step of performing copper plating after the heating/cooling step.

Accordingly, it is possible to easily form the laminate comprising more than two metal layers on the substratum film.

### EFFECTS OF THE INVENTION

According to the present invention, it is possible to suppress any warpage of the laminate by performing the heat treatment and then the cooling treatment on the metal clad laminate wherein the metal layer is formed on at least a part of the surface of the substratum film of thermoplastic having a flexibility under the state of loading the tension within the range capable of maintaining the laminate to be in the flat configuration consistently during the period from heating to cooling.

Moreover, it is able to suppress a plastic deformation of the film, and then it becomes able to suppress any warpage without a fracture in the metal clad laminate thus obtained, by controlling the tension loaded to the metal clad laminate between 0.01% and 0.3% of the tensile strength of the substratum film in the direction for loading the tension (more preferably between 0.015% and 0.15%, and further preferably between 0.02% and 0.1%).

Further, it is desirable to control the peak temperature in the heat treatment to be in the temperature range lower than the melting point temperature of the film by between 35° C. and 85° C. (more preferably, between 50° C. and 70° C.), and to perform the tension control till the film is cooled down to the temperature lower than the melting point thereof by 110° C. This is because when the peak temperature in the heat treatment becomes higher than the temperature lower than the melting point temperature of the film by 35° C., the substratum film is excessively elongated, and a warpage cannot is enlarged. On the contrary, when the peak temperature is lower than the temperature lower than the melting point temperature of the substratum film by 85° C., an adhesive strength between the film and the metal layer is not sufficient for a practical use.

Still further, the tension control is performed till the film is cooled down to a temperature lower than the melting point temperature of the film by 110° C. This is because a warpage will not occur unless an excessive force is applied at a temperature not higher than a temperature lower than the melting point temperature of the film by 110° C., even though a warpage and/or a curl may occur in the laminate, especially the substratum film, when the tension loaded to the laminate is beyond the range capable of maintaining the laminate to be in a flat configuration at a temperature higher than the temperature lower than the melting point temperature of the film by 110° C. Therefore, the metal clad laminate thus obtained has a sufficient adhesive strength between the substratum film and the metal layer, and then has a small thickness variation before and after the heat treatment. Thus, it becomes able to suppress a warpage for a whole of the laminate.

Still further, it becomes able to manufacture the metal clad laminate having less warpage for a whole of the laminate by controlling the thickness of the metal layer at the period of the heat treatment between 0.1 μm and 20 μm (more preferably between 0.1 μm and 0.5 μm).

Still further, according to the present invention, it becomes able to reduce the thickness of the metal clad laminate by bonding the metal layer and the film layer without an adhesion layer. Furthermore, it becomes able to shorten a manufacturing time by omitting a process of coating an adhesion layer.

### BRIEF DESCRIPTION OF THE DRAWINGS

FIG. 1 is one example of an exemplary diagram illustrating a configuration of a heating/cooling device for performing a heat treatment and a cooling treatment on a metal clad laminate.

FIG. 2 is another example of an exemplary diagram illustrating a configuration of a heating/cooling device for performing a heat treatment and a cooling treatment on a metal clad laminate.

### DESCRIPTION OF THE REFERENCE SYMBOLS

10, 50 HEATING AND COOLING DEVICE
11, 51 SUPPLY SPOOL
12 HEAT TREAT FURNACE
13a, 13b, 53a, 53b, 54c, 54d FIXED ROLL
14, 54 DANCER ROLL
15, 55 DANCER ROLL
20 METAL CLAD LAMINATE
52 HEAT TREAT FURNACE OF COOLING INTEGRATED TYPE
52a HEAT TREATMENT PART
52b COOLING TREATMENT PART

### BEST MODE FOR CARRYING OUT THE INVENTION

Embodiments of the present invention will be described in detail below with reference to the drawings. The embodiments are described as illustrated only, and do not limit the scope of the present invention. Therefore, those skilled in the art can employ embodiments in which the individual elements or all the elements are replaced with equivalent ones, and which are also encompassed in the scope of the present invention.

In a process for producing a metal clad laminate to which the present invention is applicable, first a metal layer is formed on at least a part of a surface of a flexible thermoplastic polymer film. Next, a heat treatment and a cooling treatment are performed on the metal clad laminate under a state of loading a tension within a range capable of maintaining the metal clad laminate to be a flat configuration. The tension within a range capable of maintaining the metal clad laminate to be a flat configuration means a tension within a range in which the metal clad laminate is not to be excessively extended or contracted in a direction for loading the tension at the period of performing the heat treatment or the cooling treatment.

It is able to perform the heat treatment using a hot blast drying furnace, an infrared heater furnace, a heated metal roll, or the like. Further, the hot blast drying furnace or the infrared heater furnace among the processes for the heat treatment is used as an in-convey furnace. An in-convey direction in the case may be a perpendicular direction or a horizontal direction to the ground, or may be a direction including both elements of the perpendicular direction and the horizontal direction as well. Further, the processes of the heat treatment and the cooling treatment may be an inline type to be continuous with the process for forming the metal layer (for example, a process for plating), or may be an individual line separated therefrom. Still further, the heat treatment may be performed as a batch type with mounting onto a metal mesh or the like, or may be performed by conveying continuously the film of roll state.

It is able to load a tension with using a dancer roll, a pinch roll, or the like, for the period of performing the heat treatment under the state of loading the tension within the range capable of maintaining the metal clad laminate to be the flat configuration, for a process to perform continuously a heat treatment using a conveying roll for example.

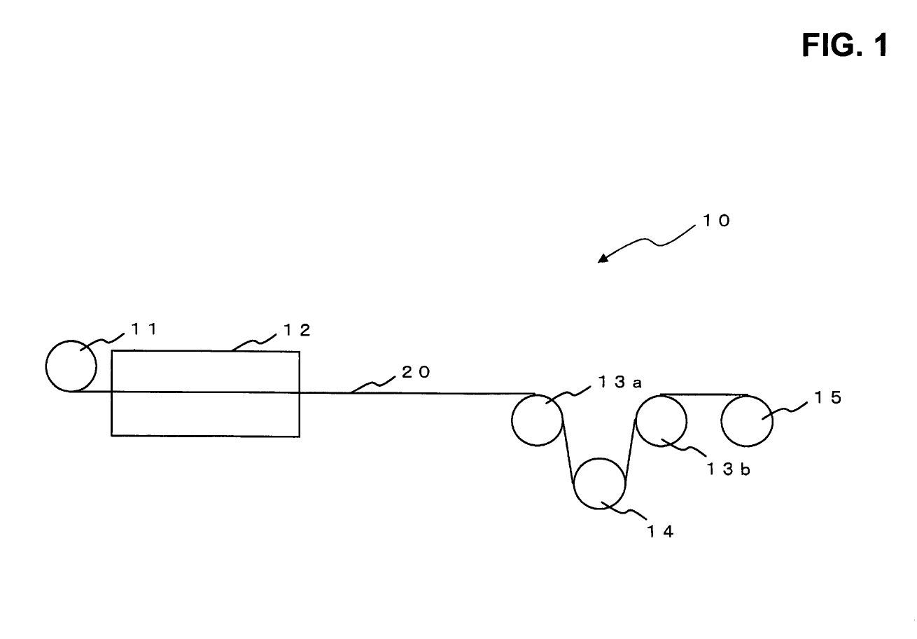

FIG. 1 is one example of an exemplary diagram illustrating a configuration of a heating and cooling device for performing a heat treatment and a cooling treatment on the metal clad laminate, which is to be used in a process for producing a metal clad laminate that the present invention is applicable thereto, under a state of loading a tension within a range capable of maintaining such the laminate to be a flat configuration.

As shown in FIG. 1, a heating and cooling device 10 comprises a supply spool 11 for supplying a metal clad laminate 20 formed at a process for forming a metal layer to at least a part of a surface of a polymer film, a heat treatment furnace 12 for performing a heat treatment for the metal clad laminate 20, fixed rolls 13a and 13b, a dancer roll 14 for loading a predetermined tension constantly for the metal clad laminate 20, and a take-up spool 15 for taking up the metal clad laminate 20.

Moreover, the metal clad laminate 20 supplied from the supply spool 11 is passed through the heat treatment furnace 12, to be conveyed in a horizontal direction to the ground to the fixed roll 13a, to be further conveyed to a take-up spool 15 via the dancer roll 14 and the fixed roll 13b, and then to be taken up by the take-up spool 15. Further, the metal clad laminate 20 is annealed in-convey in the heat treatment furnace 12, and then to be cooled down naturally at the period of being conveyed to the fixed roll 13a after being taken out from the heat treatment furnace 12.

Still further, the metal clad laminate 20 becomes a state of being loaded a tension constantly within a range capable of maintaining the metal clad laminate 20 to be a flat configuration, by a tension control using the dancer roll 14 during the conveying period thereof from the supply spool 11 to the fixed roll 13a. Furthermore, a conveying speed for the metal clad laminate 20 is controlled by the supply spool 11, the take-up spool 15 and the dancer roll 14.

According to the above described process, the metal clad laminate 20 is manufactured. By performing the heat treatment for the metal clad laminate 20 as above described, it is able to relax an internal stress difference between the different layers (the metal layer and the film layer) in the laminate, thereby suppressing warpage.

Moreover, it is able to bond the metal layer and the film layer without any adhesion layer, by loading a high temperature to the metal clad laminate 20, with using a film of thermoplastic for the above mentioned polymer film having the flexibility. Hence, it becomes able to omit a process of coating an adhesion layer and to improve a thickness of a metal clad laminate to be thinner.

Further, regarding the above mentioned heat treatment and the cooling treatment, the tension to be loaded to the metal clad laminate, that is to say, the tension within the range capable of maintaining the metal clad laminate to be the flat configuration, is between 0.01% and 0.3% of the tensile strength (in the MD direction) of the substratum film. This is because it is not able to reduce the warpage to a degree within a range available for a practical use if the tension is too small, and because the metal clad laminate, especially the substratum film part, is elongated in the tension loading direction, and then a dimensional stability becomes worse, if the tension is too large. Therefore, as a range for a tension to be loaded to the metal clad laminate, it is desirable to load a tension of between 0.01% and 0.3% of a tensile strength of a substratum film to form the metal clad laminate, further preferable to load a tension of between 0.015% and 0.15%, or a tension of between 0.02% and 0.1% in particular.

Still further, a peak temperature in the above mentioned heat treatment is in a temperature range of between 35° C. and 85° C. lower than a melting point temperature Tm of the substratum film in the metal clad laminate, that is to say, in a temperature range of between (Tm−85)° C. and (Tm−35)° C.

This is because a substratum film part is elongated and a warpage becomes large, and then a flatness of a metal clad laminate to be manufactured becomes to be lost, if a temperature is excessively high. And because an adhesive strength between a film and a metal layer is not improved to a degree available for a practical use, if a temperature is excessively low. As desirably in a case of controlling a peak temperature in a heat treatment to be in a temperature range of between (Tm−70)° C. and (Tm−50)° C., it becomes able to improve further a flatness and an adhesion of a metal clad laminate.

For example, in a case of using a thermoplastic liquid crystal polyester film (product name: Vecstar™ CT from KURARAY Co., LTD.) for a substratum film in the above mentioned metal clad laminate, it is desirable to control a peak temperature in a heat treatment between 225° C. and 275° C., or between 240° C. and 260° C. in particular, according to the melting point temperature Tm thereof as 310° C.

Moreover, controlling a tension loaded to a metal clad laminate is within a range capable of maintaining the metal clad laminate to be a flat configuration from in-process of a heat treatment to a temperature of 110° C. lower than a melting point temperature of a substratum film (Tm−110)° C. This is because a probability of occurring a warpage and/or a curl increases for the laminate, especially for the substratum film, and then as a result, there may be remained a deformation of the substratum film at the time of taking up thereof, if the tension loaded to the metal clad laminate is beyond a range capable of maintaining the laminate to be the flat configuration at a temperature of higher than the (Tm−110)° C. during a cooling of the metal clad laminate. On the contrary, it is able to neglect a plastic deformation of the substratum film even if taking up the metal clad laminate at a temperature of lower than the (Tm−110)° C., and this is the reason.

Further, a thickness of the above mentioned metal layer is between 0.1 μm and 20 μm. This is because a value of an electrical resistivity becomes high and difficult for a practical use or further higher, and then it becomes unable to use in practical, in a case where the thickness of the metal layer becomes thinner than 0.1 μm. Furthermore, in a case where the thickness of the metal layer becomes thicker than 20 μm, it becomes difficult to suppress any warpage for the metal clad laminate, and to control the flatness thereof within a range for a practical use, and this is the reason.

Therefore, it is desirable to control a thickness of the metal layers between 0.1 μm and 20 μm for a single metal layer and for a total thickness of the whole of the metal layers in a case of a plurality of metal layers, and further preferably to be as between 0.1 μm and 0.5 μm for both cases.

Moreover, it is able to apply a polyester film or the like to the above mentioned polymer film having the flexibility. In particular, a polyethylene naphthalate (PEN) is more suitable than a polyethylene terephthalate (PET), as the PEN is superior in heat resistance property to the PET.

In particular, a thermoplastic polymer to be able to form a molten phase of an optical anisotropy, a so-called thermoplastic liquid crystal polymer, is the optimum, because it has an allowable temperature limit as high as approximately 300° C. to be able to withstand a heat treatment sufficiently. Or, a polyether ether ketone (PEEK) polymer is preferable as a thermoplastic resin, though it is somewhat inferior in heat resistance property thereto. All of such the above mentioned polymer films have low water absorption properties, and it is available to use any thereof in wet plating.

Moreover, it is able to manufacture a metal clad laminate with improved adhesion between a film and a metal layer, by roughening a film surface beforehand for example, regarding a substratum film in the metal clad laminate.

Here, regarding a roughening process for a film surface, it is easy and then desirable to use a process to soak a film in an etchant for example. For the etchant, there is used such as a strong alkaline solution, a permanganate solution, a chromate solution, or the like. In a case of a thermoplastic liquid crystal polymer film in particular, it is effective to use the strong alkaline solution. While, in a case of using a film having a difficulty for etching, it is effective to use a mechanical polishing process, such as a sand blast or the like.

Moreover, a metal layer formed onto the substratum film is a Ni—P alloy layer, a Cu layer, or the like, as a single metal layer, and such as a combination of a base metal layer of Ni—P alloy and an upper part metal electrically conductive layer of Cu, or the like, as a plurality of metal layers. In a case where the metal layer is the Cu layer, a metal clad laminate is manufactured comprising the electrically conductive layer of good quality. While, in a case where the metal layer is the Ni—P alloy layer, a metal clad laminate is manufactured with having a sufficient adhesion with the substratum film. Further, in a case where the metal layer is the combined layer of the base metal layer of Ni—P alloy and the upper part metal electrically conductive layer of Cu, a metal clad laminate is manufactured with having a sufficient adhesion with the substratum film, and comprising the electrically conductive layer of good quality.

Still further, it is able to use the metal clad laminate as a one side flexible board by forming a metal layer onto one surface of a substratum film, or to use as a both sides flexible board by forming a metal layer onto each of both surfaces of a substratum film respectively. Or, it is able to use as a multilayer board as well, by overlapping a plurality of laminates that a metal layer is formed at only one surface thereof.

Still further, in the case where the heat treatment is performed for the metal clad laminate under the state of loading the tension thereto as described above, it is possible to set properly a time for the heat treatment in a temperature range of not less than the (Tm−85)° C., with considering a desired physical properties regarding a metal clad laminate to be obtained. And, it is between 30 seconds and 5 hours by ordinary, desirable to be between one minute and on hour, or further preferable to be between 3 minutes and 30 minutes.

Still further, the 1 process for the heat treatment and the cooling treatment is not limited to the in-convey annealing, and it may be also available to perform a heat treatment and then a cooling treatment with overlapping a plurality of metal clad laminates in a sheet state under a state of loading a tension in a film flow direction (MD) or in a cross direction (TD) for the individual metal clad laminates within a range capable of maintaining the metal clad laminates to be flat configurations for each thereof consistently during the period from the heat treatment to the cooling treatment.

Still further, in the case where the heat treatment and then the cooling treatment is to be performed for the metal clad laminate under the state of loading the tension within the range capable of maintaining the metal clad laminate to be flat configuration consistently during the period from heating to cooling as described above, it may be able to perform under an active gaseous atmosphere, such as in the air. However, it is desirable to perform under an inert atmosphere for preventing a metal layer from a change in color or from an oxidation on a surface thereof. Here, the inert atmosphere means in an inert gas of such as nitrogen, argon, or the like, or under reduced pressure, and it is to be that an active gas of such as oxygen or the like is not more than 0.1 vol %. In particular, a heated nitrogen gas with a purity of not less than 99.9% is to be used desirably as the inert gas.

Still further, it is possible to form a through hole, as necessary for the metal clad laminate to be manufactured using the above described process, for at least one state of a state before forming a metal layer, a state after forming the metal layer, and a state before performing a heat treatment and a cooling treatment. Furthermore, regarding a process for forming the through hole, it is able to use a processing using a drill, or a processing using a laser.

Next, some preferred examples of the present invention will be described in detail below.

### Example 1

### Examples Regarding Heat Treatment

Examples regarding a heat treatment temperature and a tension for the heat treatment will be described in detail below.

The Vecstar™ CT produced by KURARAY Co., LTD. (a thickness of 50 μm) is to be used with a width of 300 mm as a substratum film (a polymer film). Such the polymer film is to be soaked in an alkaline solution (KOH: 400 g/L) for 15 minutes at 80° C. approximately, and then an asperity is to be formed on a surface thereof as a surface roughness Rz is between 1.0 and 1.5. Next, individual treatments of a conditioner treatment, an electroless plating treatment of Ni—P alloy, an electroplating treatment of Cu and a heat treatment is to be performed in order, and then a film metal clad laminate is to be manufactured. Here, a washing in clear water or a drying is performed for the individual treatments respectively. Moreover, metal layers (a base metal layer+an upper part metal electrically conductive layer) are to be formed on both surfaces of the polymer film.

Further, in the conditioner treatment, a surface of the polymer film is to be washed in clear water with using the OPC-350 CONDITIONER produced by Okuno Chemical Industries Co., Ltd. Here, the OPC-80 CATALYST as a catalyst imparting solution including a palladium and the OPC-500 ACCELERATOR as an activating agent, produced by Okuno Chemical Industries Co., Ltd. are to be used.

Next, the following three types of metal layers are to be formed using the electroless plating, and then to be assessed. A first type is a Ni—P alloy plating, a second type is a Cu plating and a third type is a combined metal layer of a base metal layer with a Ni—P plating and an upper part metal layer with a Cu plating.

A First Type: Conditions for the Ni—P Alloy Plating

The ENPLATE™ NI-426 produced by MELTEX Inc. is to be used regarding the electroless plating treatment for the Ni—P alloy. A pH of a plating bath is to be controlled within a range between 6.0 and 7.0 using a sulfuric acid or an ammonia water, and a temperature of the bath is to be controlled within a range between 75° C. and 85° C. A plating thickness is to be between 0.1 μm and 0.5 μm.

A Second Type: Conditions for the Cu Plating

The CUPOSIT™ 328 L COPPER MIX produced by Rohm and Haas Japan K.K. is to be used regarding the electroless plating treatment for the Cu.

A Third Type: Conditions for the Combined Metal Layer of the Base Metal Layer with the Ni—P Plating and the Upper Part Metal Layer with the Cu Plating

First, the Ni—P alloy plating as the above mentioned first type is to be performed, and then the Cu plating as the above mentioned second type is to be performed. Here, it may be also available to perform the Cu plating using such as a heretofore known electroplating of Cu or the like in place of the Cu plating as the above mentioned second type.

Next, a heat treatment is to be performed for a metal clad laminate to be formed by the above described plating treatment, by in-convey annealing using a hot blast drying furnace as the heat treatment furnace 12 in the heating and cooling device 10 as shown in FIG. 1. In such the heat treatment, the metal clad laminate 20 is to be conveyed with a speed of 0.2 m/min in a horizontal direction to the ground, with loading a predetermined tension constantly using the dancer roll 14. And then the heat treatment is to be performed with a predetermined temperature uniformly in a conveying direction through the heat treatment furnace 12 with a length of approximately 1 m.

Here, a thermoplastic liquid crystal polyester film to be used as a substratum film for the metal clad laminate 20 has a melting point temperature Tm of 310° C. Therefore, a heat treatment temperature of the heat treatment furnace 12 is to be set arbitrary within a temperature range of between 225° C. and 275° C. as the temperature of between 35° C. and 85° C. lower than the Tm, and further preferably within a temperature range of between 240° C. and 260° C. as the temperature of between 50° C. and 70° C. lower than the Tm. Moreover, a tension to be loaded to the metal clad laminate 20 is to be controlled by setting a tension at the dancer roll 14 arbitrary within a range of between 27.6 kPa (0.41 N) and 828 kPa (12.4 N). Next, a cooling treatment is to be performed for not less than five minutes in a room temperature as a natural cooling, and then the metal clad laminate is to be taken up using the take-up spool 15. Here, a measurement of an actual temperature of the metal clad laminate 20 is to be performed using a type-K thermo-couple.

Moreover, it may be available to perform a heat treatment with loading a tension as described above after forming a base metal layer, and then the upper part metal electrically conductive layer may be formed thereafter, according to circumstances. Further, a time for a heat treatment in the heat treatment furnace 12 may be changed with changing the convey speed.

Here, to set the tension at the dancer roll 14 within a range of between 27.6 kPa (0.41 N) and 828 kPa (12.4 N) is because the following reason. The tensile strength of the Vecstar™ CT film as the substratum film in an MD is 276 MPa (a value measured as pursuant to the measurement method disclosed in ASTM D882). Therefore, a range becomes to be as between 27.6 kPa and 828 kPa, that are corresponding to the range of between 0.01% and 0.3% for the tensile strength in the MD of the Vecstar™ CT film. Moreover, the Vecstar™ CT film is to be used with a thickness of 50 μm and a width of 300 mm, and then a tensile load becomes to be 0.41 N corresponding to the tensile strength of 27.6 kPa, and a tensile load becomes to be 12.4 N corresponding to the tensile strength of 828 kPa.

Next, an adhesive strength, a flatness, an elongation and a seeming are examined for the metal clad laminate to be manufactured as described above. Here, regarding the adhesive strength, a tearing off strength (a peeling strength) for the metal layer is measured shown as a result, as pursuant to the mechanical performance test disclosed in JIS C5016 (the method of tearing off in a 90 degrees direction).

Regarding an assessment for the flatness, a metal clad laminate to be cut into a size of a width of 200 mm and a length of 200 mm after being performed a one side etching using a ferric chloride solution in a case of the metal clad laminate of both surfaces type, and a metal clad laminate to be cut into a size of a width of 200 mm and a length of 200 mm in a case of the metal clad laminate of one surface type are prepared. Moreover, the maximum value of warpages at the four corners of the metal clad laminates with placing on a flat board is measured. And then it is determined as EXCELLENT for the maximum value of the warps as less than 10 mm, as GOOD for that as not less than 10 mm but less than 20 mm, as ACCEPTABLE for that as not less than 20 mm but less than 100 mm, and as UNACCEPTABLE for that as not less than 100 mm.

Regarding an assessment for the elongation of the film, there are marked two dots in a tension direction thereof beforehand, next a distance M1 between the two dots is measured before the heat treatment, and then a distance M2 between the two dots is measured after the heat treatment, using a caliper. Moreover, the elongation is calculated using the following formula, and then it is to be determined as OK for the calculated value of the elongation as less than 0.3%, and as NG for that as not less than 0.3%. More specifically, there are marked scratches of cross shape at two points with a distance of approximately 500 mm in an MD of the film beforehand, and then the distance is measured before and after the heat treatment.

Elongation of a film=(M2−M1)/100 M1 (%). The assessment results are shown in Table 1 to Table 3, according to different assessment conditions. Table 1 is an assessment result regarding the metal clad laminate using the Ni—P alloy plating as the first type of the above mentioned metal layers. Table 2 is an assessment result regarding the metal clad laminate using the Cu plating as the second type of the above mentioned metal layers. Table 3 is an assessment result regarding the metal clad laminate using the combined metal layer of the base metal layer with the Ni—P plating and the upper part metal layer with the Cu plating as the third type of the above mentioned metal layers. Here, the condition using the Ni—P alloy plating is to be abbreviated as Ni in Table 1 through Table 3.

Here, the assessment conditions are regarding a heat treatment temperature and a tension. Moreover, other conditions are according to the above described conditions. That is to say, the thickness of the film layer is 50 μm approximately and the thickness of the metal layer is between 8 μm and 20 μm. Further, the following assessments are to be performed for all of the metal clad laminates respectively, after forming every metal layer with a thickness of approximately 8 μm by performing an electroplating of Cu using a copper sulfate bath as described below in a case where the thickness of the metal layer is less than 8 μm, for assessing properties of such as the adhesion, the warpage, or the like, regarding each of the metal clad laminate.

The following is to be used as a solution for the electroplating of Cu. Moreover, the CU-BRITE™ TH-R [symbol] produced by EBARA-UDYLITE CO., LTD is to be used as an additive agent.

Copper sulfate: 120 g/L,

Sulfuric acid: 150 g/L,

Concentrated hydrochloric acid: 0.125 mL/L (as a chloride ion),

Electric current density: 2 A/dm².

TABLE 1

| | | | | | | | | Assessment results | | | |
|---|---|---|---|---|---|---|---|---|---|---|---|
| | | | | | | | | Adhesive | | | |
| | | | Assessment conditions | | | | | strength | | | |
| | | | | | | | Tensile | (kN/m), | | Elongation, | |
| | | | Heat | | | | strength | Conforming | | Conforming | |
| | Metal layer | | treatment | | Tension | | ratio | product: _>0.6 | | product: | |
| | | Thickness | temperature | | (Unit: | (Unit: | (Unit: | (Unit: | | _<0.3 | Flatness |
| | Type | μm | (° C.) | | N) | kPa) | %) | kN/m) | Judgment | Judgment | Judgment |
| Invented example 1 | Ni | 0.2 | 230 | Tm-80 | 1.04 | 69 | 0.025 | 0.87 | OK | OK | ACCEPTABLE |
| Invented example 2 | Ni | 0.1 | 270 | Tm-40 | 1.04 | 69 | 0.025 | 1.41 | OK | OK | ACCEPTABLE |
| Invented example 3 | Ni | 0.3 | 230 | Tm-80 | 0.50 | 33 | 0.012 | 0.92 | OK | OK | ACCEPTABLE |
| Invented example 4 | Ni | 0.5 | 250 | Tm-60 | 0.50 | 33 | 0.012 | 1.28 | OK | OK | ACCEPTABLE |
| Invented example 5 | Ni | 0.3 | 250 | Tm-60 | 11.6 | 773 | 0.280 | 1.24 | OK | OK | ACCEPTABLE |
| Invented example 6 | Ni | 0.1 | 270 | Tm-40 | 11.6 | 773 | 0.280 | 1.45 | OK | OK | ACCEPTABLE |
| Invented example 7 | Ni | 0.4 | 235 | Tm-75 | 1.04 | 69 | 0.025 | 0.98 | OK | OK | ACCEPTABLE |
| Invented example 8 | Ni | 0.3 | 265 | Tm-45 | 1.04 | 69 | 0.025 | 1.39 | OK | OK | ACCEPTABLE |
| Invented example 9 | Ni | 0.5 | 250 | Tm-60 | 0.58 | 38 | 0.014 | 1.32 | OK | OK | ACCEPTABLE |
| Invented example 10 | Ni | 0.2 | 250 | Tm-60 | 6.42 | 428 | 0.155 | 1.29 | OK | OK | ACCEPTABLE |
| Invented example 11 | Ni | 0.2 | 245 | Tm-65 | 6.00 | 400 | 0.145 | 1.09 | OK | OK | GOOD |
| Invented example 12 | Ni | 0.5 | 245 | Tm-65 | 0.70 | 47 | 0.017 | 1.01 | OK | OK | GOOD |
| Invented example 13 | Ni | 0.3 | 255 | Tm-55 | 0.70 | 47 | 0.017 | 1.37 | OK | OK | GOOD |
| Invented example 14 | Ni | 0.4 | 255 | Tm-55 | 6.00 | 400 | 0.145 | 1.35 | OK | OK | GOOD |
| Invented example 15 | Ni | 0.2 | 245 | Tm-65 | 3.31 | 221 | 0.080 | 1.09 | OK | OK | EXCELLENT |
| Invented example 16 | Ni | 0.3 | 245 | Tm-65 | 0.91 | 61 | 0.022 | 1.01 | OK | OK | EXCELLENT |
| Invented example 17 | Ni | 0.2 | 255 | Tm-55 | 0.91 | 61 | 0.022 | 1.37 | OK | OK | EXCELLENT |
| Invented example 18 | Ni | 0.2 | 255 | Tm-55 | 3.31 | 221 | 0.080 | 1.35 | OK | OK | EXCELLENT |
| Invented example 19 | Ni | 0.1 | 250 | Tm-60 | 1.04 | 69 | 0.025 | 1.31 | OK | OK | EXCELLENT |
| Comparative example 1 | Ni | 0.3 | 150 | Tm-160 | 0.34 | 23 | 0.008 | 0.22 | NG | OK | UNACCEPTABLE |
| Comparative example 2 | Ni | 0.5 | 220 | Tm-90 | 0.34 | 23 | 0.008 | 0.56 | NG | OK | UNACCEPTABLE |
| Comparative example 3 | Ni | 0.3 | 250 | Tm-60 | 0.34 | 23 | 0.008 | 1.29 | OK | OK | UNACCEPTABLE |
| Comparative example 4 | Ni | 0.1 | 280 | Tm-30 | 0.34 | 23 | 0.008 | 1.46 | OK | NG | UNACCEPTABLE |
| Comparative example 5 | Ni | 0.3 | 280 | Tm-30 | 1.04 | 69 | 0.025 | 1.45 | OK | NG | GOOD |
| Comparative example 6 | Ni | 0.2 | 220 | Tm-90 | 1.04 | 69 | 0.025 | 0.48 | NG | OK | GOOD |
| Comparative example 7 | Ni | 0.4 | 220 | Tm-90 | 13.2 | 883.2 | 0.320 | 0.32 | NG | NG | GOOD |
| Comparative example 8 | Ni | 0.2 | 250 | Tm-60 | 13.2 | 883.2 | 0.320 | 1.33 | OK | NG | GOOD |
| Comparative example 9 | Ni | 0.1 | 300 | Tm-10 | 13.2 | 883.2 | 0.320 | 1.47 | OK | NG | GOOD |

Invented examples 1 to 19, and Comparative examples 1 to 9 are the examples that a metal layer to be performed a heat treatment is the Ni—P alloy layer. Here, each of the metal layers has a thickness of between 0.1 μm and 0.5 μm as less than 8 μm for all of the examples in Table 1. And then for assessing properties of such as the adhesion, the warpage, or the like, for all of the metal clad laminates respectively, the assessments are performed after forming every metal layer to be as a thickness of approximately 8 μm by performing the electroplating of Cu using a general copper sulfate bath.

Invented examples 1, 2, 7, 8 and 19 are the assessment results of the metal clad laminates manufactured in the case where the heat treatments are performed at the individual temperatures of 230° C. (Invented example 1), 270° C. (Invented example 2), 235° C. (Invented example 7), 265° C. (Invented example 8) and 250° C. (Invented example 19), with loading constantly the tension of 69 kPa (1.04 N) thereto respectively.

Invented examples 3 and 4 are the assessment results of the metal clad laminates manufactured in the case where the heat treatments are performed at the individual temperatures of 230° C. (Invented example 3) and 250° C. (Invented example 4), with loading constantly the tension of 33 kPa (0.5 N) thereto respectively.

Invented examples 5 and 6 are the assessment results of the metal clad laminates manufactured in the case where the heat treatments are performed at the individual temperatures of 250° C. (Invented example 5) and 270° C. (Invented example 6), with loading constantly the tension of 773 kPa (11.6 N) thereto respectively.

Invented example 9 is the assessment result of the metal clad laminate manufactured in the case where the heat treatment is performed at the temperature of 250° C., with loading constantly the tension of 38 kPa (0.58 N) thereto.

Invented example 10 is the assessment result of the metal clad laminate manufactured in the case where the heat treatment is performed at the temperature of 250° C., with loading constantly the tension of 428 kPa (6.42 N) thereto.

Invented examples 12 and 13 are the assessment results of the metal clad laminates manufactured in the case where the heat treatments are performed at the individual temperatures of 245° C. (Invented example 12) and 255° C. (Invented example 13), with loading constantly the tension of 47 kPa (0.70 N) thereto respectively.

Invented examples 11 and 14 are the assessment results of the metal clad laminates manufactured in the case where the heat treatments are performed at the individual temperatures of 245° C. (Invented example 11) and 255° C. (Invented example 14), with loading constantly the tension of 400 kPa (6.00 N) thereto respectively.

Invented examples 15 and 18 are the assessment results of the metal clad laminates manufactured in the case where the heat treatments are performed at the individual temperatures of 245° C. (Invented example 15) and 255° C. (Invented example 18), with loading constantly the tension of 221 kPa (3.31 N) thereto respectively.

Invented examples 16 and 17 are the assessment results of the metal clad laminates manufactured in the case where the heat treatments are performed at the individual temperatures of 245° C. (Invented example 16) and 255° C. (Invented example 17), with loading constantly the tension of 61 kPa (0.91 N) thereto respectively.

Comparative examples 1 to 4 are the assessment results of the metal clad laminates manufactured in the case where the heat treatments are performed at the individual temperatures of 150° C. (Comparative example 1), 220° C. (Comparative example 2), 250° C. (Comparative example 3) and 280° C. (Comparative example 4), with loading constantly the tension of 23 kPa (0.34 N) thereto respectively.

Comparative examples 5 and 6 are the assessment results of the metal clad laminates manufactured in the case where the heat treatments are performed at the individual temperatures of 280° C. (Comparative example 5) and 220° C. (Comparative example 6), with loading constantly the tension of 69 kPa (1.04 N) thereto respectively.

Comparative examples 7 to 9 are the assessment results of the metal clad laminates manufactured in the case where the heat treatments are performed at the individual temperatures of 220° C. (Comparative example 7), 250° C. (Comparative example 8) and 300° C. (Comparative example 9), with loading constantly the tension of 883.2 kPa (13.2 N) thereto respectively.

As will be noted from Table 1, according to Invented examples 1 to 19, the adhesive strength is not less than 0.6 kN/m for all thereof, and the assessment of the flatness is less than 100 mm (that is to say, ACCEPTABLE or better) for all thereof. Moreover, the elongation is less than 0.3% for all thereof, and there is no fracture seemingly at all for all of the metal clad laminates. Hence, according to Invented examples 1 to 19, it becomes able to obtain the metal clad laminates of good quality with the sufficient adhesive strength, relatively less warpage, no variation in elongation and no fracture before and after the heat treatment. According to Invented examples 15 to 19 in particular, it becomes able to obtain the metal clad laminates of further better quality as the warpage becomes to be as less than 10 mm, at the temperature conditions of between 245° C. and 255° C., and at the tension conditions of between 55 kPa (0.8 N) and 276 kPa (4.1 N).

Further, according to Comparative examples 1, 2, 6 and 7, the adhesive strength becomes to be too low at the temperature conditions of not higher than 220° C., and then it is confirmed that it becomes hard to use for real the metal clad laminates manufactured thereby.

Still further, according to Comparative examples 4, 5 and 9, the elongation becomes to be too large at the temperature conditions of not lower than 280° C., and then it is confirmed that it becomes hard to use for real the metal clad laminates manufactured thereby.

Still further, according to Comparative examples 1 to 4, the flatness becomes to be worse (that is to say, the warpage is too large) at the tension conditions of not stronger than 23 kPa (0.24 N), and then it is confirmed that it becomes hard to use for real the metal clad laminates manufactured thereby.

Furthermore, according to Comparative examples 7 to 9, the elongation becomes to be too large at the tension conditions of stronger than 883 kPa (13.2 N), and then it is confirmed that it becomes hard to use for real the metal clad laminates manufactured thereby.

TABLE 2

| | | | | | | | | Assessment results | | | |
|---|---|---|---|---|---|---|---|---|---|---|---|
| | | | | | | | | Adhesive | | | |
| | | | Assessment conditions | | | | | strength | | | |
| | | | | | | | Tensile | (kN/m), | | Elongation, | |
| | | | Heat | | | | strength | Conforming | | Conforming | |
| | Metal layer | | treatment | | Tension | | ratio | product: _>0.6 | | product: | |
| | | Thickness | temperature | | (Unit: | (Unit: | (Unit: | (Unit: | | _<0.3 | Flatness |
| | Type | μm | (° C.) | | N) | kPa) | %) | kN/m) | Judgment | Judgment | Judgment |
| Invented example 20 | Cu | 0.5 | 230 | Tm-80 | 1.04 | 69 | 0.025 | 0.62 | OK | OK | ACCEPTABLE |
| Invented example 21 | Cu | 1.2 | 270 | Tm-40 | 1.04 | 69 | 0.025 | 1.2 | OK | OK | ACCEPTABLE |
| Invented example 22 | Cu | 18 | 230 | Tm-80 | 0.50 | 33 | 0.012 | 1.5 | OK | OK | ACCEPTABLE |
| Invented example 23 | Cu | 0.5 | 250 | Tm-60 | 0.50 | 33 | 0.012 | 0.98 | OK | OK | ACCEPTABLE |
| Invented example 24 | Cu | 8 | 250 | Tm-60 | 11.6 | 773 | 0.280 | 1.02 | OK | OK | ACCEPTABLE |
| Invented example 25 | Cu | 6 | 270 | Tm-40 | 11.6 | 773 | 0.280 | 0.92 | OK | OK | ACCEPTABLE |
| Invented example 26 | Cu | 6 | 235 | Tm-75 | 1.04 | 69 | 0.025 | 0.88 | OK | OK | ACCEPTABLE |
| Invented example 27 | Cu | 0.2 | 265 | Tm-45 | 1.04 | 69 | 0.025 | 0.68 | OK | OK | ACCEPTABLE |
| Invented example 28 | Cu | 12 | 250 | Tm-60 | 0.58 | 38 | 0.014 | 1.32 | OK | OK | ACCEPTABLE |
| Invented example 29 | Cu | 2 | 250 | Tm-60 | 6.42 | 428 | 0.155 | 1.15 | OK | OK | ACCEPTABLE |
| Invented example 30 | Cu | 3 | 245 | Tm-65 | 6.00 | 400 | 0.145 | 0.81 | OK | OK | GOOD |
| Invented example 31 | Cu | 2 | 245 | Tm-65 | 0.70 | 47 | 0.017 | 0.86 | OK | OK | GOOD |
| Invented example 32 | Cu | 0.6 | 255 | Tm-55 | 0.70 | 47 | 0.017 | 0.96 | OK | OK | GOOD |
| Invented example 33 | Cu | 0.8 | 255 | Tm-55 | 6.00 | 400 | 0.145 | 1.22 | OK | OK | GOOD |
| Invented example 34 | Cu | 1.2 | 245 | Tm-65 | 3.31 | 221 | 0.080 | 0.84 | OK | OK | EXCELLENT |
| Invented example 35 | Cu | 5 | 245 | Tm-65 | 0.91 | 61 | 0.022 | 0.75 | OK | OK | EXCELLENT |
| Invented example 36 | Cu | 5 | 255 | Tm-55 | 0.91 | 61 | 0.022 | 0.93 | OK | OK | EXCELLENT |
| Invented example 37 | Cu | 5 | 255 | Tm-55 | 3.31 | 221 | 0.080 | 0.97 | OK | OK | EXCELLENT |
| Invented example 38 | Cu | 0.6 | 250 | Tm-60 | 1.04 | 69 | 0.025 | 1.03 | OK | OK | EXCELLENT |
| Comparative example 10 | Cu | 0.2 | 150 | Tm-160 | 0.34 | 23 | 0.008 | 0.13 | NG | OK | UNACCEPTABLE |
| Comparative example 11 | Cu | 3 | 220 | Tm-90 | 0.34 | 23 | 0.008 | 0.23 | NG | OK | UNACCEPTABLE |
| Comparative example 12 | Cu | 4 | 250 | Tm-60 | 0.34 | 23 | 0.008 | 0.85 | OK | OK | UNACCEPTABLE |
| Comparative example 13 | Cu | 0.5 | 280 | Tm-30 | 0.34 | 23 | 0.008 | 0.95 | OK | NG | UNACCEPTABLE |
| Comparative example 14 | Cu | 1.5 | 280 | Tm-30 | 1.04 | 69 | 0.025 | 1.2 | OK | NG | GOOD |
| Comparative example 15 | Cu | 6 | 220 | Tm-90 | 1.04 | 69 | 0.025 | 0.36 | NG | OK | GOOD |
| Comparative example 16 | Cu | 8 | 220 | Tm-90 | 13.2 | 883.2 | 0.320 | 0.24 | NG | NG | GOOD |
| Comparative example 17 | Cu | 12 | 250 | Tm-60 | 13.2 | 883.2 | 0.320 | 0.98 | OK | NG | GOOD |
| Comparative example 18 | Cu | 18 | 300 | Tm-10 | 13.2 | 883.2 | 0.320 | 1.36 | OK | NG | GOOD |

Invented examples 20 to 38, and Comparative examples 10 to 18 are the examples that a metal layer to be performed a heat treatment is the Cu layer. Here, for assessing properties of such as the adhesion, the warpage, or the like, for all of the metal clad laminates respectively, the assessments are performed after forming every metal layer to be as a thickness of approximately 8 μm by performing the electroplating of Cu using a general copper sulfate bath regarding examples in which the individual metal layers has a thickness of less than 8 μm among the examples in Table 2. Moreover, each of the heat treatment temperatures and each of the tension conditions for Invented examples 20 to 38 are similar to that for Invented examples 1 to 19 respectively, and each of the heat treatment temperatures and each of the tension conditions for Comparative examples 10 to 18 are similar to that for Comparative examples 1 to 9 respectively.

According to the assessment results as shown in Table 2, it is obvious that there is obtained the tendency for every case as similar to that according to Invented examples 1 to 19 and Comparative examples 1 to 9 as shown in Table 1.

TABLE 3

| | | | | | Assessment conditions | | | | | Assessment results | | | |
|---|---|---|---|---|---|---|---|---|---|---|---|---|---|
| | | | | | Heat | | | | | Adhesive | | Elon- | |
| | | | | | treat- | | | | | strength | | gation. | |
| | Base | | Upper part | | ment | | | | Tensile | (kN/m). | | Conform- | |
| | metal layer | | metal layer | | tem- | | | | strength | Conforming | | ing | |
| | | Thick- | | Thick- | pera- | | Tension | | ratio | product: _>0.6 | | product: | |
| | | ness | | ness | ture | | (Unit: | (Unit: | (Unit: | (Unit: | Judg- | <0.3 | Flatness |
| | Type | μm | Type | μm | (° C.) | | N) | kPa) | %) | kN/m) | ment | Judgment | Judgment |
| Invented example 39 | Ni | 0.1 | Cu | 2 | 230 | Tm-80 | 1.04 | 69 | 0.025 | 0.92 | OK | OK | ACCEPTABLE |
| Invented example 40 | Ni | 0.1 | Cu | 2 | 270 | Tm-40 | 1.04 | 69 | 0.025 | 1.35 | OK | OK | ACCEPTABLE |
| Invented example 41 | Ni | 0.2 | Cu | 1 | 230 | Tm-80 | 0.50 | 33 | 0.012 | 1.02 | OK | OK | ACCEPTABLE |
| Invented example 42 | Ni | 0.5 | Cu | 1 | 250 | Tm-60 | 0.50 | 33 | 0.012 | 1.08 | OK | OK | ACCEPTABLE |
| Invented example 43 | Ni | 0.5 | Cu | 5 | 250 | Tm-60 | 11.6 | 773 | 0.280 | 1.18 | OK | OK | ACCEPTABLE |
| Invented example 44 | Ni | 0.1 | Cu | 5 | 270 | Tm-40 | 11.6 | 773 | 0.280 | 1.35 | OK | OK | ACCEPTABLE |
| Invented example 45 | Ni | 0.4 | Cu | 5 | 235 | Tm-75 | 1.04 | 69 | 0.025 | 0.89 | OK | OK | ACCEPTABLE |
| Invented example 46 | Ni | 0.4 | Cu | 5 | 265 | Tm-45 | 1.04 | 69 | 0.025 | 1.24 | OK | OK | ACCEPTABLE |
| Invented example 47 | Ni | 0.1 | Cu | 2 | 250 | Tm-60 | 0.58 | 38 | 0.014 | 1.32 | OK | OK | ACCEPTABLE |
| Invented example 48 | Ni | 0.3 | Cu | 2 | 250 | Tm-60 | 6.42 | 428 | 0.155 | 1.05 | OK | OK | ACCEPTABLE |
| Invented example 49 | Ni | 0.3 | Cu | 3 | 245 | Tm-65 | 6.00 | 400 | 0.145 | 0.98 | OK | OK | GOOD |
| Invented example 50 | Ni | 0.5 | Cu | 3 | 245 | Tm-65 | 0.70 | 47 | 0.017 | 1.32 | OK | OK | GOOD |
| Invented example 51 | Ni | 0.2 | Cu | 3 | 255 | Tm-55 | 0.70 | 47 | 0.017 | 1.02 | OK | OK | GOOD |
| Invented example 52 | Ni | 0.1 | Cu | 2 | 255 | Tm-55 | 6.00 | 400 | 0.145 | 1.35 | OK | OK | GOOD |
| Invented example 53 | Ni | 0.1 | Cu | 1 | 245 | Tm-65 | 3.31 | 221 | 0.080 | 1.02 | OK | OK | EXCELLENT |
| Invented example 54 | Ni | 0.1 | Cu | 5 | 245 | Tm-65 | 0.91 | 61 | 0.022 | 0.88 | OK | OK | EXCELLENT |
| Invented example 55 | Ni | 0.3 | Cu | 3 | 255 | Tm-55 | 0.91 | 61 | 0.022 | 1.26 | OK | OK | EXCELLENT |
| Invented example 56 | Ni | 0.3 | Cu | 5 | 255 | Tm-55 | 3.31 | 221 | 0.080 | 1.38 | OK | OK | EXCELLENT |
| Invented example 57 | Ni | 0.1 | Cu | 8 | 250 | Tm-60 | 1.04 | 69 | 0.025 | 1.35 | OK | OK | EXCELLENT |
| Comparative example 19 | Ni | 0.2 | Cu | 2 | 150 | Tm-160 | 0.34 | 23 | 0.008 | 0.19 | NG | OK | UNACCEPTABLE |
| Comparative example 20 | Ni | 0.1 | Cu | 2 | 220 | Tm-90 | 0.34 | 23 | 0.008 | 0.34 | NG | OK | UNACCEPTABLE |
| Comparative example 21 | Ni | 0.2 | Cu | 2 | 250 | Tm-60 | 0.34 | 23 | 0.008 | 1.05 | OK | OK | UNACCEPTABLE |
| Comparative example 22 | Ni | 0.1 | Cu | 3 | 280 | Tm-30 | 0.34 | 23 | 0.008 | 1.35 | OK | NG | UNACCEPTABLE |
| Comparative example 23 | Ni | 0.4 | Cu | 3 | 280 | Tm-30 | 1.04 | 69 | 0.025 | 1.65 | OK | NG | GOOD |
| Comparative example 24 | Ni | 0.5 | Cu | 3 | 220 | Tm-90 | 1.04 | 69 | 0.025 | 0.37 | NG | OK | GOOD |
| Comparative example 25 | Ni | 0.4 | Cu | 4 | 220 | Tm-90 | 13.2 | 883.2 | 0.320 | 0.31 | NG | NG | GOOD |
| Comparative example 26 | Ni | 0.2 | Cu | 8 | 250 | Tm-60 | 13.2 | 883.2 | 0.320 | 1.2 | OK | NG | GOOD |
| Comparative example 27 | Ni | 0.3 | Cu | 1 | 300 | Tm-10 | 13.2 | 883.2 | 0.320 | 1.38 | OK | NG | GOOD |

Invented examples 39 to 57, and Comparative examples 19 to 27 are the examples that a metal layer to be performed a heat treatment is the combined metal layer of the base metal layer of Ni—P and the upper part metal layer of Cu. Here, regarding examples in which the individual metal layers has a thickness of less than 8 μm among the examples in Table 3, for assessing properties of such as the adhesion, the warpage, or the like, for all of the metal clad laminates respectively, the assessments are performed after forming every metal layer to be as a thickness of approximately 8 μm by performing the electroplating of Cu using a general copper sulfate bath. Moreover, each of the heat treatment temperatures and each of the tension conditions for Invented examples 39 to 57 are similar to that for Invented examples 1 to 19 respectively, and each of the heat treatment temperatures and each of the tension conditions for Comparative examples 19 to 27 are similar to that for Comparative examples 1 to 9 respectively.

According to the assessment results as shown in Table 3, it is obvious that there is obtained the tendency for every case as similar to that according to Invented examples 1 to 19 and Comparative examples 1 to 9 as shown in Table 1, and similar to that according to Invented examples 20 to 38 and Comparative examples 10 to 18 as shown in Table 2.

### (Examples Regarding Cooling Treatment)

Examples regarding a cooling treatment for a metal clad laminate will be described in detail below.

First, The Vecstar™ CT produced by KURARAY Co., LTD. (a thickness of 50 μm) is to be used with a width of 300 mm as a polymer film, as described in the examples regarding the above mentioned heat treatment, and then a surface roughening is to be performed thereon using a strong alkaline solution. Next, individual treatments of a conditioner treatment, a base plating treatment (an electroless plating treatment of Ni—P alloy, or an electroless plating treatment of Cu), and a heat treatment is to be performed in order, and then a film metal clad laminate is to be manufactured. Moreover, in a case where a metal layer is a Ni—P alloy base metal layer/a Cu upper part metal electrically conductive layer structure, an electroplating treatment of Cu is to be performed after performing the electroless plating treatment of Ni—P alloy, and then a heat treatment is to be performed.

Further, in the conditioner treatment, a surface of the polymer film is to be washed in clear water with using the OPC-350 CONDITIONER produced by Okuno Chemical Industries Co., Ltd. Here, the OPC-80 CATALYST as a catalyst imparting solution including a palladium and the OPC-500 ACCELERATOR as an activating agent, produced by Okuno Chemical Industries Co., Ltd. are to be used.

Still further, the CHEMICAL NICKEL EXC produced by Okuno Chemical Industries Co., Ltd. is to be used as a plating solution regarding the electroless plating treatment for the Ni—P alloy, and the CUPOSIT™ 328 L COPPER MIX produced by Rohm and Haas Japan K.K. is to be used as a plating solution regarding the electroless plating treatment for the Cu. Here, a plating thickness of a base metal layer by each of the base plating treatments is to be between 0.1 μm and 0.5 μm.

Furthermore, in a case of forming an upper part metal layer, there is used a general copper sulfate bath as a solution for an electroplating of Cu as similar to the plating solution according to the example regarding the heat treatment, and a plating thickness is to be as between 2 μm and 8 μm.

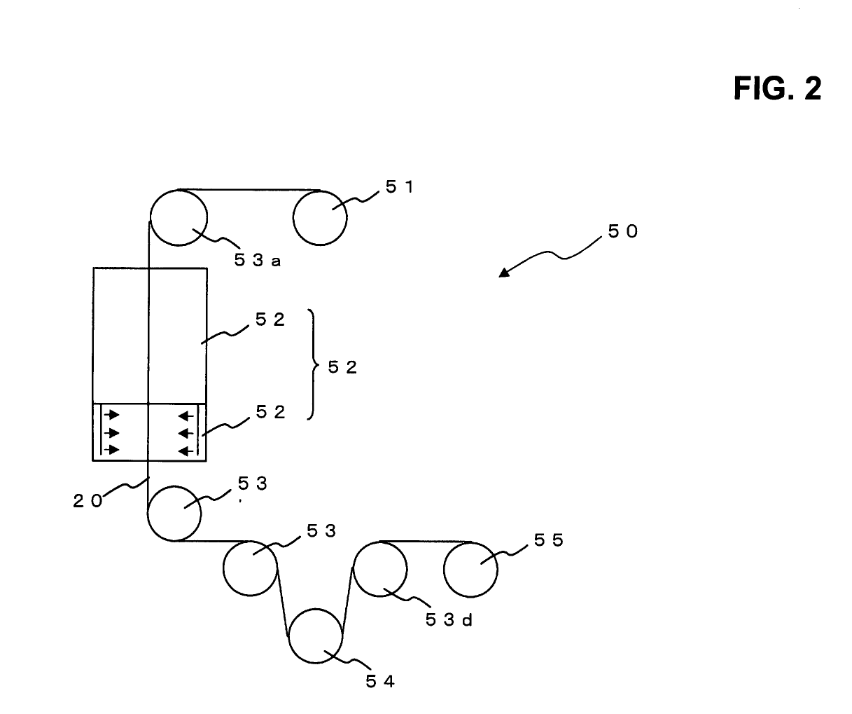

Next, a heating and cooling device to be used in the examples regarding the cooling treatment will be described in detail below. FIG. 2 is one example of an exemplary diagram illustrating a configuration of another heating and cooling device for performing a heat treatment and then a cooling treatment for a metal clad laminate, which is used in a process for producing a metal clad laminate that the present invention is applicable thereto, under a state of loading a tension within a range capable of maintaining such the laminate to be a flat configuration.

As shown in FIG. 2, a heating and cooling device 50 comprises a supply spool 51 for supplying a metal clad laminate 20 formed at a process for forming a metal layer to at least a part of a surface of a polymer film, a heat treatment furnace of cooling integrated type 52 for performing a heat treatment and a cooling treatment for the metal clad laminate 20, fixed rolls 53a, 53b, 53c and 53d, a dancer roll 54 for loading a predetermined tension constantly for the metal clad laminate 20, and a take-up spool 55 for taking up the metal clad laminate 20.

Moreover, the heat treatment furnace of cooling integrated type 52 is a hot blast circulating furnace with a length of approximately 2 m, and comprises a heat treatment part 52a at a charging side thereof to perform a heat treatment for the metal clad laminate 20, and a cooling treatment part 52b at an extracting side of the heat treatment furnace of cooling integrated type 52 as a downstream of the heat treatment part 52a.

And then the metal clad laminate 20 supplied from the supply spool 51 is to be passed through via the fixed roll 53a to the heat treatment furnace of cooling integrated type 52, to be conveyed in a horizontal direction to the ground to the fixed roll 53b, to be conveyed to a take-up spool 55 via the fixed roll 53c, the dancer roll 54 and the fixed roll 53d, and then to be taken up by the take-up spool 55.

Further, the metal clad laminate 20 becomes to be a state of being loaded a tension constantly within a range capable of maintaining to be a flat configuration, by a tension control using the dancer roll 54 during the conveying period thereof from the fixed spool 53a to the fixed roll 53b. Furthermore, a conveying speed for the metal clad laminate 20 is to be controlled by using the supply spool 51, the take-up spool 55 and the dancer roll 54.

Here, a heat treatment is to be performed at a heat treatment temperature of 260° C. for the metal clad laminate to be formed, under a state of loading the tension of 69 kPa (1.04 N) thereto.

Moreover, regarding a cooling treatment, a cooling temperature is to be changed by controlling an air flow amount with blowing an atmosphere. Further, regarding the cooling temperature, a temperature of a thermo-couple set at the cooling treatment part 52b is to be monitored.

Furthermore, for assessing properties of such as the flatness, the elongation, or the like, for all of the metal clad laminates respectively, an electroplating of Cu is to be performed using a general copper sulfate bath as similar to the plating solution according to the examples regarding the heat treatment in a case where the thickness of the metal layer is less than 8 μm, and then the thickness of the metal layer becomes to be as approximately 8 μm regarding each of such the metal clad laminate.

Regarding the metal clad laminate to be manufactured as described above, the flatness, the elongation are to be examined. Here, an assessment process for the flatness and an assessment process for the elongation of a film are similar to that according to the examples regarding the heat treatment.

Assessment results are shown in Table 4, according to a difference of the assessment conditions. Here, the assessment conditions are regarding a cooling treatment temperature. Moreover, other conditions are according to the above described conditions. That is to say, a thickness of a film layer is 50 μm approximately.

TABLE 4

| | Assessment conditions | | | | | | | | | |
|---|---|---|---|---|---|---|---|---|---|---|
| | | | | | Heat | | | | | |
| | | | Upper part | | treatment | Tension | | Cooling | | |
| | Base | | metal | | temperature | | (Unit: | temperature | Assessment results | |
| | metal layer | | layer | | (° C.) | (Unit: N) | kPa) | (° C.) | Elongation | Flatness |
| Invented example 58 | Ni | 0.1 μm | NONE | | 260 | 1.04 | 69 | 50 | OK | GOOD |
| Invented example 59 | Ni | 0.3 μm | NONE | | 260 | 1.04 | 69 | 100 | OK | GOOD |
| Invented example 60 | Ni | 0.2 μm | NONE | | 260 | 1.04 | 69 | 195 | OK | GOOD |
| Invented example 61 | Cu | 0.2 μm | NONE | | 260 | 1.04 | 69 | 50 | OK | GOOD |
| Invented example 62 | Cu | 0.3 μm | NONE | | 260 | 1.04 | 69 | 100 | OK | GOOD |
| Invented example 63 | Cu | 0.3 μm | NONE | | 260 | 1.04 | 69 | 195 | OK | GOOD |
| Invented example 64 | Ni | 0.2 μm | Cu | 2 μm | 260 | 1.04 | 69 | 50 | OK | GOOD |
| Invented example 65 | Ni | 0.1 μm | Cu | 5 μm | 260 | 1.04 | 69 | 100 | OK | GOOD |
| Invented example 66 | Ni | 0.4 μm | Cu | 8 μm | 260 | 1.04 | 69 | 195 | OK | GOOD |
| Comparative example 28 | Ni | 0.5 μm | NONE | | 260 | 1.04 | 69 | 205 | OK | UNACCEPTABLE |
| Comparative example 29 | Ni | 0.3 μm | NONE | | 260 | 1.04 | 69 | 225 | OK | UNACCEPTABLE |
| Comparative example 30 | Ni | 0.2 μm | NONE | | 260 | 1.04 | 69 | 245 | OK | UNACCEPTABLE |
| Comparative example 31 | Cu | 0.1 μm | NONE | | 260 | 1.04 | 69 | 205 | OK | UNACCEPTABLE |
| Comparative example 32 | Cu | 0.3 μm | NONE | | 260 | 1.04 | 69 | 225 | OK | UNACCEPTABLE |
| Comparative example 33 | Cu | 0.5 μm | NONE | | 260 | 1.04 | 69 | 245 | OK | UNACCEPTABLE |
| Comparative example 34 | Ni | 0.3 μm | Cu | 2 μm | 260 | 1.04 | 69 | 205 | OK | UNACCEPTABLE |
| Comparative example 35 | Ni | 0.3 μm | Cu | 5 μm | 260 | 1.04 | 69 | 225 | OK | UNACCEPTABLE |
| Comparative example 36 | Ni | 0.4 μm | Cu | 8 μm | 260 | 1.04 | 69 | 245 | OK | UNACCEPTABLE |

Invented examples 58 to 60 are the assessment results of the metal clad laminates manufactured in the case where the base metal layers are the Ni—P alloy layers and the cooling treatments are performed thereto at the individual cooling temperatures of 50° C. (Invented example 58), 100° C. (Invented example 59) and 195° C. (Invented example 60) respectively.

Invented examples 61 to 63 are the assessment results of the metal clad laminates manufactured in the case where the base metal layers are the Cu layers and the cooling treatments are performed thereto at the individual cooling temperatures of 50° C. (Invented example 61), 100° C. (Invented example 62) and 195° C. (Invented example 63) respectively.

Invented examples 64 to 66 are the assessment results of the metal clad laminates manufactured in the case where each of the metal layers are comprised of the base metal layer and the upper part metal electrically conductive layer, wherein the base metal layers are the Ni—P alloy layers and the upper part metal electrically conductive layers are the Cu layers, and the cooling treatments are performed thereto at the individual cooling temperatures of 50° C. (Invented example 64), 100° C. (Invented example 65) and 195° C. (Invented example 66) respectively.

Comparative examples 28 to 30 are the assessment results of the metal clad laminates manufactured in the case where the base metal layers are the Ni—P alloy layers and the cooling treatments are performed thereto at the individual cooling temperatures of 205° C. (Comparative example 28), 225° C. (Comparative example 29) and 245° C. (Comparative example 30) respectively.

Comparative examples 31 to 33 are the assessment results of the metal clad laminates manufactured in the case where the base metal layers are the Cu layers and the cooling treatments are performed thereto at the individual cooling temperatures of 205° C. (Comparative example 31), 225° C. (Comparative example 32) and 245° C. (Comparative example 33) respectively.

Comparative examples 34 to 36 are the assessment results of the metal clad laminates manufactured in the case where each of the metal layers are comprised of the base metal layer and the upper part metal electrically conductive layer, wherein the base metal layers are the Ni—P alloy layers and the upper part metal electrically conductive layers are the Cu layers, and the cooling treatments are performed thereto at the individual cooling temperatures of 205° C. (Comparative example 34), 225° C. (Comparative example 35) and 245° C. (Comparative example 36) respectively.

As will be noted from Table 4, according to Invented examples 58 to 66, the assessment of the flatness is less than 20 mm (that is to say, GOOD) for all thereof. Moreover, the elongation is less than 0.3% for all thereof, and there is no fracture seemingly at all for all of the metal clad laminates. Hence, according to Invented examples 58 to 66, that is to say, at the cooling temperatures of not higher than 200° C., it becomes able to obtain the metal clad laminates of good quality with relatively less warpage, and little variation in elongation before and after the heat treatment.

Moreover, it becomes able to obtain the metal clad laminates of good quality with relatively less warpage, and little variation in elongation before and after the heat treatment, even in the case where the copper plating thickness becomes to be thicker according to Invented examples 22 to 24, by performing further the copper plating after the heat treatment and then the cooling treatment.

Further, according to Comparative examples 28 to 36, it is confirmed that the warpage occurs in the case where the cooling treatment temperature is not sufficiently low.

### (Examples Regarding Substratum Film)

Examples regarding a type of a substratum film and a presence of a surface treatment for the substratum film in a metal clad laminate will be described in detail below. Here, a metal clad laminate is to be manufactured as the following points are different from that of the metal clad laminates manufactured in the examples regarding the heat treatment as described above, and then an adhesive strength, a flatness and an elongation are to be examined.

As a substratum film of a metal clad laminate, a thermoplastic liquid crystal polymer, a polyethylene naphthalate (PEN), a polyethylene terephthalate (PET) and a polyether ether ketone (PEEK) are to be adopted respectively, with a film thickness of approximately 50 μm thereof respectively. In the case where the substratum films are the PET and the PEN, asperities are to be formed on each of the surfaces thereof by a sand blast processing as a mat treatment for such the substrate films. In the case where the substratum film is the PEEK, an asperity is to be performed on a surface thereof as a surface roughness Rz is between 1.0 and 3.0 by soaking such the substratum film in an alkaline solution. Moreover, a Ni—P layer as a base metal layer is to be formed with a thickness of 0.3 μm regarding forming metal layers thereon respectively. Further, a heat treatment is to be performed for five minutes at a temperature of 60° C. lower than each of the melting point temperatures of the individual substratum films (Tm−60° C.) respectively, with loading a tension with a tensile strength of 69 kPa (1.04 N) respectively. Furthermore, a Cu layer is to be formed thereon with a thickness of 8 μm as an upper part metal electrically conductive layer respectively. And then regarding such the individual film metal clad laminates, an adhesive strength, a flatness and an elongation are to be examined. Here, an assessment process for the adhesive strength, an assessment process for the flatness and an assessment process for the elongation of the films are similar to that according to the examples regarding the heat treatment.

Assessment results are shown in Table 5, according to a difference of the substratum films.

TABLE 5

| | | | Assessment conditions | | | Assessment results | | |
|---|---|---|---|---|---|---|---|---|
| | | | Heat | | | Adhesive strength | | |
| | | | treatment | | | (kN/m), | | |
| | | Tm | temperature | Tension | | Conforming | | |
| | Film substratum | (° C.) | (° C.) | (Unit: N) | (Unit: kPa) | product: _>0.8 | Elongation | Flatness |
| Invented example 67 | Thermoplastic liquid crystal polymer | 310 | 250 | 1.04 | 69 | 1.27 | OK | GOOD |
| Invented example 68 | Polyethylene naphthalate (PEN) | 272 | 225 | 1.04 | 69 | 0.89 | OK | GOOD |
| Invented example 69 | Polyethylene terephthalate (PET) | 256 | 209 | 1.04 | 69 | 0.81 | OK | GOOD |
| Invented example 70 | Polyether ether ketone (PEEK) | 335 | 288 | 1.04 | 69 | 1.41 | OK | GOOD |

Invented examples 67 to 70 are the assessment results of the metal clad laminates with using the substratum films of the thermoplastic liquid crystal polymer (Invented example 67), PEN (Invented example 68), PET (Invented example 69) and PEEK (Invented example 70) respectively.

As will be noted from Table 5, according to Invented examples 67 to 70, the adhesive strength is not less than 0.8 kN/m for all thereof, and the assessment of the flatness is less than 20 mm (that is to say, GOOD) for all thereof. Moreover, the elongation is less than 0.3% for all thereof, and there is no fracture seemingly at all for all of the metal clad laminates. Hence, according to each of the metal clad laminates that the asperity is performed on the surface of the polyethylene naphthalate (PEN), the polyethylene terephthalate (PET), or on the polyether ether ketone (PEEK) respectively, it is able to obtain the value available for a practical use regarding all of the adhesive strength, the flatness and the elongation.

1. A process for producing a metal clad laminate having flexibility and comprising a substratum film formed of a thermoplastic and a metal layer, comprising:
a heating/cooling step of performing a heat treatment and a cooling treatment on a laminate formed of the substratum film and the metal layer under a state of receiving a stress within a range capable of consistently maintaining the laminate to be in a flat posture during an entire period of heating and cooling.

2. A process for producing a metal clad laminate having flexibility and comprising a substratum film formed of a thermoplastic and a metal layer, comprising:
a laminate forming step of forming the metal layer on at least a part of a surface of the substratum film; and
a heating/cooling step of performing a heat treatment and then a cooling treatment on a laminate formed in the laminate forming step under a state of receiving a tension within a range capable of consistently maintaining the laminate to be in a flat posture during an entire period of heating and cooling,
wherein the substratum film is a polymer film having flexibility.

3. The process for producing a metal clad laminate according to claim 1, wherein, in the heating/cooling step, said laminate receives the tension between 0.01% and 0.3% of a tensile strength of the substratum film within the range capable of maintaining the laminate to be in the flat posture.

4. The process for producing a metal clad laminate according to claim 1, wherein, in the heating/cooling step, said laminate receives the tension between 0.015% and 0.15% of a tensile strength of the substratum film within the range capable of maintaining the laminate to be in the flat posture.

5. The process for producing a metal clad laminate of according to claim 1, wherein, in the heating/cooling step, said laminate receives the tension between 0.02% and 0.1% of a tensile strength of the substratum film within the range capable of maintaining the laminate to be in the flat posture.

6. The process for producing a metal clad laminate according claim 1, wherein, in the heating/cooling step, said laminate has a temperature having a peak temperature in a temperature range lower than a melting point temperature of the substratum film by between 35° C. and 85° C. in the heat treatment.

7. The process for producing a metal clad laminate according to claim 1, wherein, in the heating/cooling step, said laminate has a temperature having a peak temperature in a temperature range lower than a melting point temperature of the substratum film by between 50° C. and 70° C. in the heat treatment.

8. The process for producing a metal clad laminate according to claim 1, wherein said laminate is cooled down from a temperature of the heat treatment to a temperature lower than the melting point temperature of the substratum film by not less than 110° C., while controlling the tension loaded to the laminate within the range capable of maintaining the laminate to be in the flat posture.

9. The process for producing a metal clad laminate according to claim 1, wherein, in the heating/cooling step, said metal layer has a thickness between 0.1 μm and 20 μm.

10. The process for producing a metal clad laminate according to claim 1, wherein, in the heating/cooling step, said metal layer has a thickness between 0.1 μm and 0.5 μm.

11. The process for producing a metal clad laminate according to claim 1, wherein said metal layer is formed of copper, a copper alloy, nickel, or a nickel alloy.

12. The process for producing a metal clad laminate according to claim 1, wherein said substratum film is a polymer resin film capable of forming a molten phase with an optical anisotropy.

13. The process for producing a metal clad laminate according to claim 1, wherein said substratum film is formed of a polyethylene terephthalate (PET) resin.

14. The process for producing a metal clad laminate according to claim 1, wherein said substratum film is formed of a polyethylene naphthalate (PEN) resin.

15. The process for producing a metal clad laminate according to claim 1, wherein said substratum film is formed of a polyether ether ketone (PEEK) resin.

16. The process for producing a metal clad laminate according to claim 1, further comprising a copper plating step of performing copper plating after the heating/cooling step.
